(19) United States
(12) Patent Application Publication
(10) Pub. No.: US 2026/0369684 A1
(43) Pub. Date: Nov. 19, 2026

(54) ELECTRODE ASSEMBLY FOR RECHARGEABLE BATTERY AND MANUFACTURING METHOD THREREOF

(71) Applicant: SAMSUNG SDI CO., LTD., Yongin-si (KR)

(72) Inventors: Heesoo YUN, Yongin-si (KR); Minhyung GUEN, Yongin-si (KR)

(73) Assignee: SAMSUNG SDI CO., LTD., Yongin-si (KR)

(21) Appl. No.: 19/406,267

(22) Filed: Dec. 2, 2025

(30) Foreign Application Priority Data
May 15, 2025 (KR) 10-2025-0063416

(51) Int. Cl. H01M 10/0585; H01M 50/46; H01M 50/54

(52) U.S. Cl. CPC H01M 10/0585; H01M 50/46; H01M 50/54

(57) ABSTRACT

An electrode assembly for a rechargeable battery, and a method for manufacturing the electrode assembly are disclosed. The electrode assembly includes a separator, and a pair of electrodes positioned with the separator interposed therebetween. At least one electrode of a pair of electrodes includes a plurality of substrates having a plurality of apertures and being stacked at a distance from each other along the thickness direction of the electrode. A plurality of active material layers filling the plurality of apertures and positioned between the plurality of substrates and outside the outermost substrate of the plurality of substrates. At least two of the plurality of substrates have different thicknesses, and at least two of the plurality of active material layers have different thicknesses.

### CROSS-REFERENCE TO RELATED APPLICATION

This application claims priority to Korean Patent Application No. 10-2025-0063416 filed with the Korean Intellectual Property Office on May 15, 2025, the entire contents of which are incorporated herein by reference.

### BACKGROUND

### (a) Field of the Disclosure

The present disclosure relates to a rechargeable battery, and more particularly, the present disclosure relates to an electrode assembly for a rechargeable battery, and to a manufacturing method thereof.

### (b) Description of the Related Art

Rechargeable batteries are widely used in various fields, such as, e.g., power sources for small electronic devices, power sources for driving motors in electric vehicles, and energy storage devices for renewable energy facilities. Recently, as the spread of electric vehicles increases, increasing energy density of rechargeable batteries may be advantageous.

### SUMMARY

The present disclosure describes an electrode assembly for a rechargeable battery, and a manufacturing method thereof, that may increase energy density and simultaneously or contemporaneously improve charge/discharge reaction speed.

An electrode assembly for a rechargeable battery according to an example embodiment includes a separator, and a pair of electrodes having the separator interposed therebetween. At least one electrode of a pair of electrodes includes a plurality of substrates having a plurality of openings, and stacked at a distance from each other along the thickness direction of the electrodes, and a plurality of active material layers filling the plurality of openings and positioned between the plurality of substrates and outside the outermost substrate of the plurality of substrates. At least two of the plurality of substrates have different thicknesses.

The plurality of substrates may have a smaller thickness away from the center according to the thickness direction. The distance between the plurality of substrates in the thickness direction may decrease away from the center according to the thickness direction

A plurality of openings may have the same size. The plurality of substrates have a greater number of openings away from the center along the thickness direction. On the other hand, at least two of the plurality of openings may have different sizes. The plurality of substrates may have larger-sized openings away from the center along the thickness direction.

The plurality of substrates may include a plurality of active parts in contact with a plurality of active material layers and in which a plurality of openings are located, and a plurality of tab parts connected to the plurality of active parts. The plurality of tab parts may include portions that are in close contact with each other.

An electrode assembly for a rechargeable battery according to another example embodiment includes a separator and a pair of electrodes having the separator interposed therebetween. At least one electrode of a pair of electrodes includes a plurality of substrates having a plurality of openings and stacked at a distance from each other along the thickness direction of the electrodes, and a plurality of active material layers filling the plurality of openings and positioned between the plurality of substrates and outside the outermost substrate of the plurality of substrates. At least two of the plurality of substrates have different thicknesses, and at least two of the plurality of active material layers have different thicknesses.

The plurality of active material layers may have a smaller thickness away from the center according to the thickness direction. The plurality of substrates may have a smaller thickness away from the center according to the thickness direction.

A plurality of openings may have the same size. The plurality of substrates may have a large number of openings away from the center along the thickness direction. On the other hand, at least two of the plurality of openings may have different sizes. The plurality of substrates may have larger-sized openings away from the center along the thickness direction.

The plurality of substrates may have a larger aperture ratio away from the center along the thickness direction. The greatest aperture ratio in a plurality of substrates may be approximately 70% or less, and the smallest aperture ratio may be approximately 30% or more.

The substrate having the smallest thickness in the plurality of substrates may have a thickness of approximately 1µm or more. The substrate having the greatest thickness in the plurality of substrates may have a thickness of approximately 8 µm or less. The active material layer having the smallest thickness in the plurality of active material layers may have a thickness of approximately 10 µm or more. The active material layer having the greatest thickness in the plurality of active material layers may have a thickness of approximately 100 µm or less.

The plurality of substrates may include a plurality of active parts in contact with a plurality of active material layers and containing a plurality of openings, and a plurality of tab parts connected to the plurality of active parts. The plurality of tab parts may include portions that are in close contact with each other.

A method of manufacturing an electrode assembly for a rechargeable battery according to an example embodiment includes manufacturing a first sheet comprising a first substrate provided with a plurality of openings and a pair of first active material layers located on both sides of the first substrate, manufacturing a pair of second sheets, each second sheet including a second substrate provided with a plurality of openings and a pair of second active material layers located on both sides of the second substrate, stacking the pair of second sheets with the first sheet interposed therebetween, and rolling a stacked body of the first sheet and the pair of second sheets. The thickness of the first substrate is greater than the thickness of the second substrate, and the thickness of each of, or at least one of, the pair of first active material layers is greater than the thickness of each of, or at least one of, the pair of second active material layers.

A pair of rollers may be prepared. The first sheet and the pair of second sheets may be transferred toward the pair of rollers while being spaced apart from each other, and may be stacked and rolled while passing between the pair of rollers.

A first coating machine and a pair of second coating machines may be prepared. The first substrate, having the first active material layer formed on a bottom surface thereof, may form the first active material layer on a top surface thereof while passing through the first coating machine during transfer. A pair of second substrates, each having the second active material layer formed on a bottom surface thereof, may form the second active material layer on a top surface thereof while passing through the second coating machine during transfer.

A pair of rollers may be prepared behind the first coating machine and a pair of second coating machines. The first sheet and a pair of second sheets may be stacked and rolled while passing between a pair of rollers.

According to example embodiments, the charge/discharge reaction speed of a rechargeable battery may be increased, and the content of active material may be increased, which is advantageous in manufacturing a high-capacity rechargeable battery.

### BRIEF DESCRIPTION OF THE DRAWINGS

FIG. 1 is a perspective view of a rechargeable battery according to an example embodiment.

FIG. 2 is a cross-sectional view of a rechargeable battery taken along line II-II of FIG. 1 as a reference.

FIG. 3 is a partially exploded sectional view of an electrode assembly according to an example embodiment.

FIG. 4 is a partially enlarged cross-sectional view of an electrode assembly according to an example embodiment.

FIG. 5 is a partially enlarged cross-sectional view showing an electrode assembly of a comparative example.

FIG. 6 is a drawing showing a modified example of the electrode assembly illustrated in FIG. 4.

FIGS. 7 and 8 are drawings showing other modified examples of the electrode assembly shown in FIG. 4.

FIG. 9 is a schematic perspective view showing another modified example of the electrode assembly.

FIG. 10 is a partially enlarged cross-sectional view of the electrode assembly shown in FIG. 9.

FIG. 11 is a process flowchart illustrating a manufacturing method of an electrode assembly according to an example embodiment.

FIG. 12 is a schematic diagram showing an example of an apparatus for manufacturing the electrode assembly shown in FIG. 11.

FIG. 13 is a process flowchart illustrating a manufacturing method of an electrode assembly according to another example embodiment.

FIG. 14 is a schematic diagram showing an example of an apparatus for manufacturing the electrode assembly shown in FIG. 13.

### DETAILED DESCRIPTION

Hereinafter, various example embodiments of the present disclosure are described in detail with reference to the accompanying drawings so that those skilled in the art may readily implement the present disclosure. The present disclosure may be implemented in various different forms, and is not limited to the example embodiments described herein.

When the terms "about" or “substantially” are used in this specification in connection with a numerical value, it is intended that the associated numerical value include a tolerance of ±10% around the stated numerical value. When ranges are specified, the range includes all values therebetween such as increments of 0.1%.

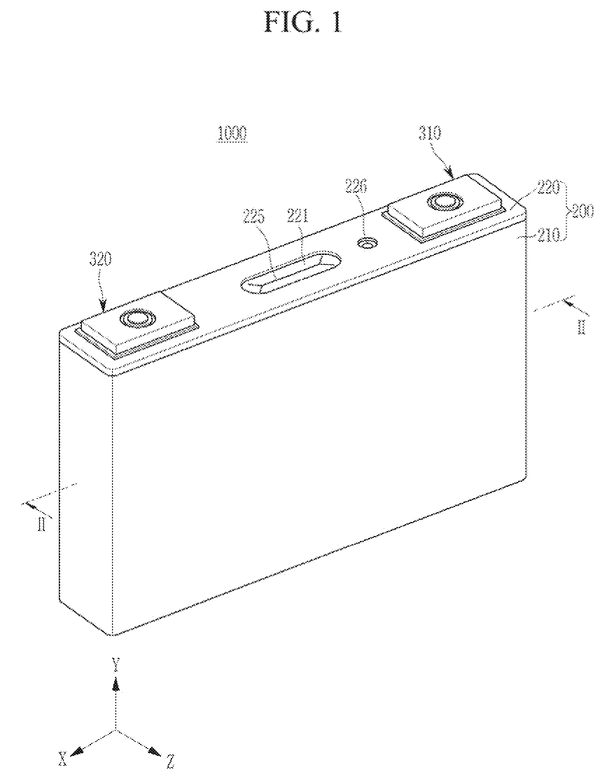

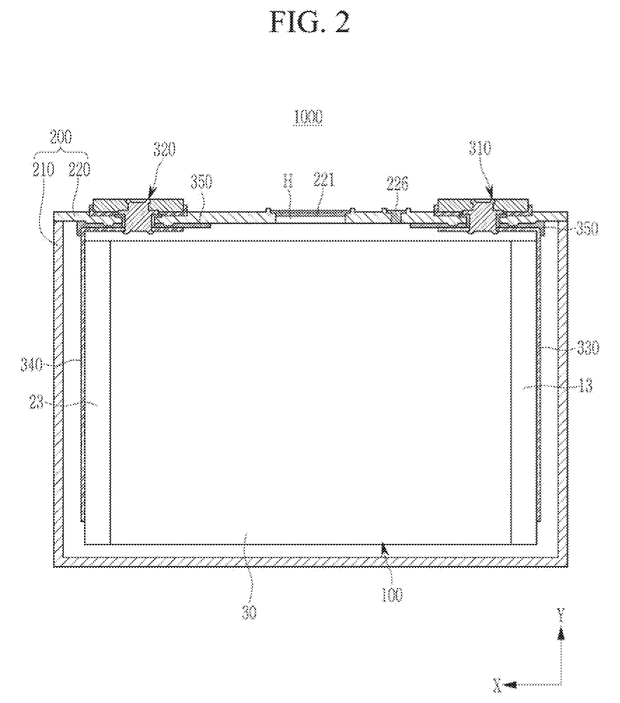

FIG. 1 is a perspective view of a rechargeable battery according to an example embodiment. FIG. 2 is a cross-sectional view of a rechargeable battery taken along line II-II of FIG. 1 as a reference.

Referring to FIGS. 1 and 2, the example embodiment of a rechargeable battery 1000 includes an electrode assembly 100, a case 200 that accommodates and seals the electrode assembly 100, and an electrolyte (e.g., electrolyte solution) in an internal space. The case 200 may include a can 210 that accommodates an electrode assembly 100 and an electrolyte in a concave internal space, and a cap plate 220 that is coupled to an open end of the can 210 to seal the can 210. A positive terminal 310 and a negative terminal 320 may be positioned in the cap plate 220.

The electrode assembly 100 includes a separator and a pair of electrodes positioned with the separator interposed therebetween. A pair of electrodes includes a positive electrode and a negative electrode. The electrode assembly 100 may be configured as a stacked type or a wound type. Hereinafter, a case where the electrode assembly 100 is a stacked type is described as an example.

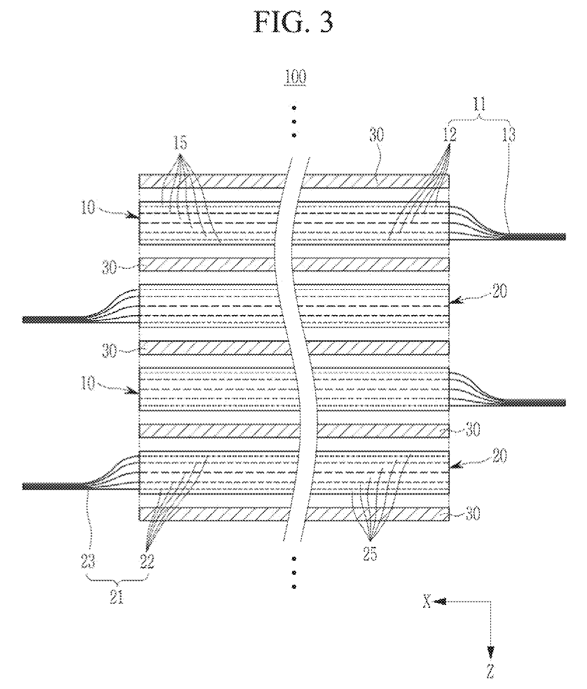

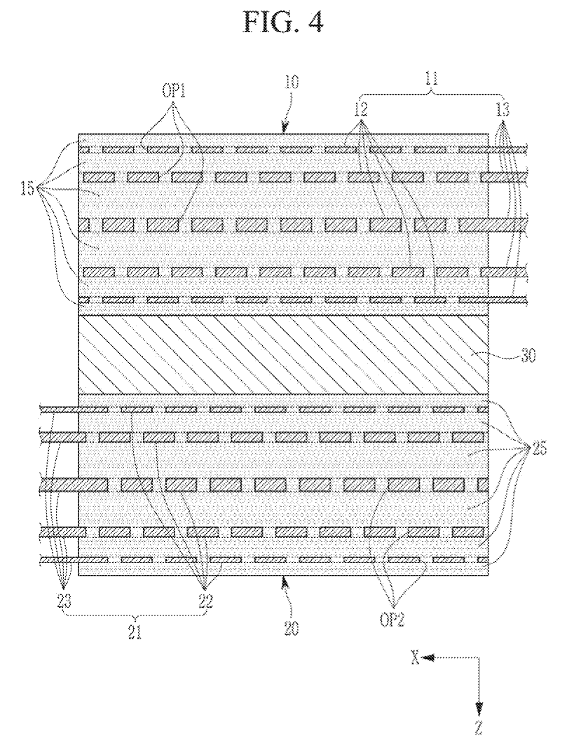

FIG. 3 is a partially exploded sectional view of an electrode assembly according to an example embodiment. FIG. 4 is a partially enlarged cross-sectional view of an electrode assembly according to an example embodiment.

Referring to FIGS. 2-4, the electrode assembly 100 may include a plurality of positive electrodes 10, a plurality of negative electrodes 20, and a plurality of separators 30. A plurality of positive electrodes 10 and a plurality of negative electrodes 20 may be alternately stacked one by one, with a separator 30 interposed therebetween. Each of, or at least one of, the plurality of positive electrode 10, the plurality of negative electrode 20, and the plurality of separators 30 may have a rectangular sheet shape. The separator 30 physically separates the positive electrode 10 and the negative electrode 20.

At least one positive electrode 10 among the plurality of positive electrodes 10 has a structure described below. For example, each of, or at least one of, the plurality of positive electrodes 10 may have a structure to be described below.

The positive electrode 10 may include a plurality of positive substrates 11, and a plurality of positive active material layers 15. At least two of the plurality of positive substrates 11 may have different thicknesses, and at least two of the plurality of positive active material layers 15 may have different thicknesses. Each of, or at least one of, the plurality of positive substrates 11 may include a positive active part 12 that contacts the positive active material layer 15, and a positive tab part 13 that does not contact the positive active material layer 15. The plurality of positive substrates 11 may include a plurality of positive active parts 12 and a plurality of positive tab parts 13.

The plurality of positive active material layers 15 may be positioned between the plurality of positive active parts 12 and on the outside of the outermost positive active part 12 among the plurality of positive active parts 12. The plurality of positive active parts 12 may be positioned with the positive active material layer 15 interposed therebetween, and may be stacked with a distance (a distance corresponding to the thickness of the positive active material layer 15) from each other in the thickness direction (Z direction) of the positive electrode 10.

The plurality of positive tab parts 13 may be in close contact with each other. For example, the plurality of positive tab parts 13 may be integrally fixed by, e.g., welding, or the like. The positive tab part 13 may be referred to as a positive uncoated part, and may be located on one side of the positive active part 12 (e.g., on the right side on FIGS. 3 and 4). Throughout the electrode assembly 100, a plurality of positive tab parts 13 included in a plurality of positive electrodes 10 may be integrally fixed by, e.g., welding, or the like.

A plurality of first openings OP1 may be positioned in each of, or in at least one of, the plurality of positive active parts 12. A plurality of positive active material layers 15 may be positioned between a plurality of positive active parts 12 while filling the plurality of first openings OP1. The plurality of first openings OP1 may have any one of a circular shape, a polygonal shape, a cross shape, and a rod shape, but are not limited thereto. The plurality of positive active parts 12 may be referred to as a porous substrate or a porous current collector.

Each of, or at least one of, the plurality of positive substrates 11 may be composed of or include a thin metal plate or a metal mesh having desired or improved electrical conductivity. When the positive substrate 11 is formed of or include a thin metal plate, the plurality of first openings OP1 may be formed in the positive active part 12 using a conventional process such as, e.g., punching or etching. The metal mesh includes a plurality of fine holes, and when the positive substrate 11 is formed of or include a metal mesh, the size of each of, or at least one of, the plurality of first openings OP1 located in the positive active part 12 may be larger than the size of each of, or at least one of, the plurality of fine holes located in the positive tab part 13.

Each of, or at least one of, the plurality of positive substrates 11 may be composed of or include thin aluminum plate, or aluminum mesh, but is not limited to these examples. A plurality of positive substrates 11 support a plurality of positive active material layers 15 and provide a path for the movement of charges generated in the positive active material layers 15.

The positive active material layer 15 includes a positive active material, and may further include a binder and/or a conductive material. The positive active material may include a lithium transition metal complex oxide. The lithium transition metal complex oxide may include at least one of, for example, a lithium-nickel-based oxide, a lithium-cobalt-based oxide, a lithium-manganese-based oxide, a lithium-iron phosphate-based compound, and a cobalt-free lithium nickel-manganese-based oxide.

As the positive active material layer 15 is positioned while filling the plurality of first openings OP1, the loading amount of the positive active material layer 15 in the positive electrode 10 may be increased. That is, the loading amount of the positive active material layer 15 may be increased by the volume occupied by the plurality of first opening OP1 in the positive electrode 10. In addition, the part of the positive active material layer 15 filled in the plurality of first openings OP1 may physically and electrically connect the two positive active material layers 15 positioned on both sides of the positive active part 12 to promote an electrochemical reaction of the plurality of positive active material layers 15.

At least one negative electrode 20 among the plurality of negative electrodes 20 has a structure described below. For example, each of, or at least one of, the plurality of negative electrodes 20 may have a structure as described below.

The negative electrode 20 may include a plurality of negative substrates 21 and a plurality of negative active material layers 25. At least two of the plurality of negative substrates 21 may have different thicknesses, and at least two of the plurality of negative active material layers 25 may have different thicknesses. Each of, or at least one of, the plurality of negative substrates 21 may include a negative active part 22 that contacts the negative active material layer 25, and a negative tab part 23 that does not contact the negative active material layer 25. A plurality of negative substrates 21 may include a plurality of negative active parts 22 and a plurality of negative tab parts 23.

A plurality of negative active material layers 25 may be positioned between the plurality of negative active parts 22 and on the outside of the outermost negative active part 22 among the plurality of negative active parts 22. A plurality of negative active parts 22 may be positioned with a negative active material layer 25 therebetween, and may be stacked with a distance (a distance corresponding to the thickness of the negative active material layer 25) therebetween along the thickness direction (Z direction) of the negative electrode 20.

A plurality of negative tab parts 23 may be in close contact with each other. For example, a plurality of negative tab parts 23 may be integrally fixed by a joining method such as, e.g., welding. The negative tab part 23 may be referred to as the negative uncoated region, and may be positioned on the other side of the negative active part 22 (e.g., the left side with reference to FIGS. 3 and 4). Throughout the electrode assembly 100, the plurality of negative tab parts 23 included in the plurality of negative electrodes 20 may be integrally fixed by a joining method such as, e.g., welding.

A plurality of second openings OP2 may be positioned in each of, or in at least one of, the plurality of negative active parts 22. A plurality of negative active material layers 25 may be positioned between a plurality of negative active parts 22 while filling a plurality of second openings OP2. The plurality of second openings OP2 may have any one of a circular shape, a polygonal shape, a cross shape, and a rod shape, but are not limited thereto. The plurality of negative active parts 22 may be referred to as a porous substrate, or a porous current collector.

Each of, or at least one of, the plurality of negative substrates 21 may be composed of or include a thin metal plate or metal mesh having desired or improved electrical conductivity. When the negative substrate 21 is composed of or include a thin metal plate, a plurality of second openings OP2 may be formed in the negative active part 22 using a conventional punching or etching process. The metal mesh basically includes a plurality of fine holes, and when the negative substrate 21 is formed of or include a metal mesh, the size of each of, or at least one of, the plurality of second openings OP2 positioned in the negative active part 22 may be larger than the size of each of, or at least one of, the plurality of fine holes positioned in the negative tab part 23.

Each of, or at least one of, the plurality of negative substrates 21 may be formed of or include a thin nickel plate, a nickel mesh, a thin copper plate, or a copper mesh, but is not limited to these examples. A plurality of negative substrates 21 support a plurality of negative active material layers 25, and provide a path for moving charges generated from the negative active material layer 25.

The negative active material layer 25 may include a negative active material, and may further include a binder and/or conductive material. The negative active material may include at least one of carbon-based active material and silicon-based active material. The carbon-based active material may include at least one of natural graphite and artificial graphite. The silicon-based active material may include at least one of silicon-carbon composite active material, silicon oxide (SiOx, 0<x≤2), and silicon carbide (SiC).

As the negative active material layer 25 is positioned while filling a plurality of second openings OP2, the loading amount of the negative active material layer 25 at the negative electrode 20 may be increased. That is, the loading amount of the negative active material layer 25 may be increased as much as the volume occupied by the plurality of second openings OP2 in the negative electrode 20. In addition, the part of the negative active material layer 25 filled in the plurality of second openings OP2 may physically and electrically connect the two negative active material layers 25 positioned on both sides of the negative active part 22 to promote the electrochemical reaction of the plurality of negative active material layers 25.

In each of, or one of, the positive active material layer 15 and the negative active material layer 25, the binder may include at least one of an aqueous binder, a non-aqueous binder, and a dry binder. In each of, or one of, the positive active material layer 15 and the negative active material layer 25, the conductive material may include at least one of a carbon-based material such as natural graphite, artificial graphite, carbon black, carbon fiber, carbon nanofiber, and carbon nanotube, a metal material in the form of a metal powder or a metal fiber including at least one of copper, nickel, aluminum, silver, or the like, and a conductive polymer such as a polyphenylene derivative.

The separator 30 may be formed of or include a porous substrate, or may be formed of or include a porous substrate in which a coating layer is positioned on at least one surface thereof. The porous substrate may include at least one of polyethylene, polypropylene, polyethylene terephthalate, polypropylene terephthalate, polybutylene terephthalate, polyester, polycarbonate, and polyimide. The coating layer may include a binder, and the binder may include a polyvinylidene fluoride-based compound.

In the electrode assembly 100 of the above-described configuration, the smaller the thickness of the plurality of positive active material layers 15, the farther away they may be from the center of the positive electrode 10, and the larger the thickness, the closer they may be to the center of the positive electrode 10. In this example, the center of the positive electrode 10 may be the center of a virtual line crossing the positive electrode 10 along the thickness direction (Z direction) of the positive electrode 10.

The positive substrate 11 may also be positioned farther from the center of the positive electrode 10 as the thickness is smaller, and may be positioned closer to the center of the positive electrode 10 as the thickness is larger. The positive substrate 11 having a relatively small thickness is suitable for supporting the positive active material layer 15 having a relatively small thickness, and the positive substrate 11 having a relatively large thickness is suitable for supporting the positive active material layer 15 having a relatively large thickness.

The smaller the thickness of the plurality of negative active material layers 25, the more distant the plurality of negative active material layers 25 may be from the center of the negative electrode 20, and the larger the thickness, the closer the plurality of negative active material layers 25 can be to the center of the negative electrode 20. In this example, the center of the negative electrode 20 may be the center of a virtual line crossing the negative electrode 20 along the thickness direction (Z direction) of the negative electrode 20.

The smaller the thickness of the plurality of negative substrates 21, the farther away the plurality of negative substrates 21 may be positioned from the center of the negative electrode 20, and the larger the thickness, the closer the plurality of negative substrates 21 may be positioned to the center of the negative electrode 20. The negative substrate 21 having a relatively small thickness is suitable for supporting the negative active material layer 25 having a relatively small thickness, and the negative substrate 21 having a relatively large thickness is suitable for supporting the negative active material layer 25 having a relatively large thickness.

The electrode assembly 100 may be accommodated in the internal space of the case 200 together with an electrolyte, for example, an electrolyte solution. The electrolyte solution may enable the movement of lithium ions between the positive electrode 10 and the negative electrode 20, and may include a lithium salt, an organic solvent, and an additive agent. The separator 30 contains an electrolyte solution due to the porous structure thereof, and may pass lithium ions.

During the charging process, lithium ions may be deintercalated from the positive active material layer 15, and intercalated into the negative active material layer 25. During the discharging process, lithium ions may be deintercalated from the negative active material layer 25, and intercalated into the positive active material layer 15. The charging and discharging reaction of the rechargeable battery may proceed inward from the surface of the electrode facing the counter electrode. When the electrode is the positive electrode 10, the counter electrode is the negative electrode 20. When the electrode is the negative electrode 20, the counter electrode is the positive electrode 10.

In the electrode assembly 100 of the example embodiment, the positive electrode 10 may have a configuration in which the thickness of the positive active material layer 15 becomes smaller as the positive active material layer 15 is closer to the negative electrode 20 along the thickness direction (Z direction), and the distance between the positive active material layer 15 and the positive active part 12 becomes smaller. In addition, the negative electrode 20 may have a configuration in which the thickness of the negative active material layer 25 becomes smaller the closer the negative active material layer 25 is to the positive electrode 10 along the thickness direction (Z direction), and the distance between the negative active material layer 25 and the negative active part 22 becomes smaller.

Accordingly, the closer the positive electrode 10 is to the negative electrode 20, the shorter the electron transfer path from the positive active material layer 15 to the positive active part 12, and the closer the positive electrode 10 is to the negative electrode 20, the shorter the electron transfer path from the negative active material layer 25 to the negative active part 22. Therefore, the electrode assembly 100 of the example embodiment may increase the charging/discharging reaction speed by the above-described electrode configuration.

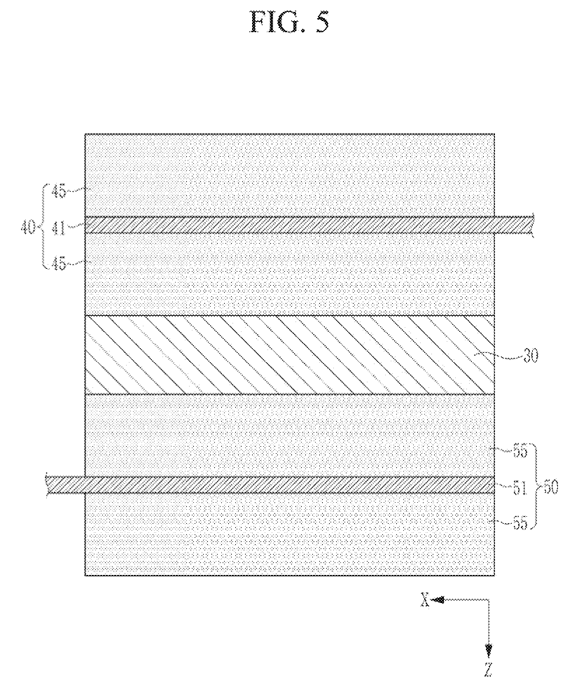

FIG. 5 is a partially enlarged cross-sectional view showing an electrode assembly of a comparative example.

Referring to FIG. 5, in a general rechargeable battery, a positive electrode 40 includes one positive substrate 41 and a pair of positive active material layers 45 positioned on both surfaces of the positive substrate 41. In addition, a negative electrode 50 includes one negative substrate 51 and a pair of negative active material layers 55 positioned on both sides of the negative substrate 51.

Referring to FIGS. 4 and 5, the thickness of each of, or at least one of, the plurality of positive active material layers 15 in the electrode assembly 100 of this example embodiment illustrated in FIG. 4 is smaller than the thickness of the positive active material layer 45 of the comparative example illustrated in FIG. 5. Additionally, the thickness of each of, or at least one of, the plurality of negative active material layers 25 illustrated in FIG. 4 is smaller than the thickness of the negative active material layer 55 of the comparative example illustrated in FIG. 5.

The reduction in the thickness of the active material layers 15 and 25 in the electrode assembly 100 of this example embodiment is advantageous in lowering the risk of dropping the active material in the process of manufacturing the electrode assembly 100. The dropping of the active material means that some of the materials constituting the active material layers 15 and 25 are separated from the active material layers 15 and 25.

In addition, the electrode assembly 100 of this example embodiment can reduce the content of the binder and the conductive material in the active material layers 15 and 25 due to the small thickness of the active material layers 15 and 25, thereby increasing the content of the active material as much as the content of the lower binder and the conductive material. Therefore, the electrode assembly 100 of the example embodiment is advantageous in manufacturing a high-capacity rechargeable battery.

In FIG. 4, five positive substrates 11 having three different thicknesses, and six positive active material layers 15 having three different thicknesses are illustrated as examples. In addition, FIG. 4 illustrates five negative substrates 21 having three different thicknesses, and six negative active material layers 25 having three different thicknesses as examples.

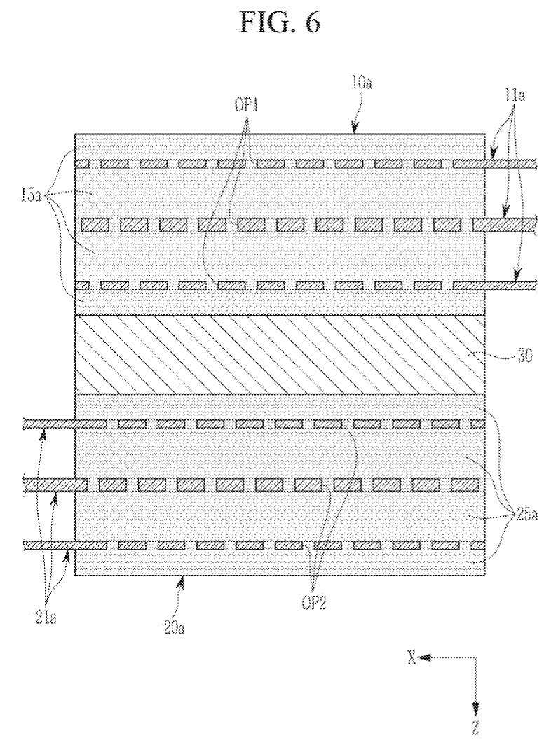

FIG. 6 illustrates a modified example of the electrode assembly illustrated in FIG. 4.

Referring to FIG. 6, the positive electrode 10a may include three positive substrates 11a having two different thicknesses, and four positive active material layers 15a having two different thicknesses. The negative electrode 20a may include three negative substrate 21a having two different thicknesses, and four layers of negative active material layer 25a having two different thicknesses.

Referring to FIGS. 4 and 6, the positive substrate having the smallest thickness among the plurality of positive substrates 11 and 11a, and the negative substrate having the smallest thickness among the plurality of negative substrates 21 and 21a, may have a thickness of about 1 µm or more. When the thickness is less than approximately 1 µm, there may be difficulties in transport during the process of forming the active material layer 15, 15a, 25, 25a and the process of stacking multiple positive electrodes 10 (10a) and multiple negative electrodes 20 (20a), and the possibility of damage may increase. For example, the positive substrate having the smallest thickness and the negative substrate having the smallest thickness may have a thickness in a range of approximately 1 µm to 2 µm.

The positive substrate having the greatest thickness among the plurality of positive substrates 11 and 11a and the negative substrate having the greatest thickness among the plurality of negative substrates 21 and 21a may have a thickness of approximately 8 µm or less. When the thickness exceeds about 8 µm, the volume of the substrates 11, 11a, 21, 21a occupied in the positive electrodes 10 (10a) or the negative electrodes 20 (20a) increases, and thus the capacities of the positive electrodes 10 (10a) or the negative electrodes 20 (20a) may be reduced. In addition, if (when) the thickness exceeds about 8 µm, welding defects may occur when welding multiple tab parts, and if (when) an internal short circuit occurs in the electrode, the resistance of the substrate may be excessively low, resulting in a large short-circuit current. For example, the positive substrate having the greatest thickness and the negative substrate having the greatest thickness may have a thickness in a range of approximately 4 µm to 8 µm.

The thinnest positive active material layer among the plurality of positive active material layers 15 and 15a, and the thinnest negative active material layer among the plurality of negative active material layers 25 and 25a, may each have a thickness of approximately 10 µm or more. When the thickness is less than about 10µm, the thickness may be difficult to achieve by actual coating due to excessively thin thickness. For example, the thinnest positive active material layer and the thinnest negative active material layer may each have a thickness in a range of approximately 10 µm to 25 µm.

The thickest positive active material layer among the plurality of positive active material layers 15 and 15a, and the thickest negative active material layer among the plurality of negative active material layers 25 and 25a, may each have a thickness in a range of approximately 100 µm or less. When the thickness exceeds about 100 µm, the conductivity of the electrode is degraded, and a part of the active material constituting the active material layer after the electrode is manufactured may be readily deintercalated. For example, the thickest positive active material layer and the thickest negative active material layer may each have a thickness in a range of approximately 50 µm to 100 µm.

In the positive electrodes 10 and 10a, the plurality of first openings OP1 may be positioned to be shifted from each other in the surface direction of the positive electrodes 10 and 10a with the plurality of first openings OP1 positioned in the adjacent positive electrode substrates 11 and 11a in the thickness direction (Z direction) of the positive electrodes 10 and 10a. The surface directions of the positive electrodes 10 and 10a are perpendicular to the thickness direction (Z direction), and may be, for example, parallel to the X direction of the drawing.

Because the plurality of positive active material layers 15 and 15a are complexly connected to each other in three dimensions at various positions instead of at a predetermined or desired position along the thickness direction (Z direction) of the positive electrodes 10 and 10a, the adhesive force of the plurality of positive active material layers 15 to the plurality of positive substrates 11 and 11a may be increased throughout the positive electrodes 10 and 10a.

In addition, in the negative electrodes 20 and 20a, the plurality of second openings OP2 may be shifted from each other in the surface direction of the negative electrodes 20 and 20a and the plurality of second openings OP2 located in the adjacent negative substrates 21 and 21a along the thickness direction (Z direction) of the negative electrodes 20 and 20a. A surface direction of the negative electrodes 20 and 20a is perpendicular to a thickness direction (Z direction), and may be, for example, parallel to an X direction of the drawing.

The plurality of negative active material layers 25 and 25a are complexly connected to each other in three dimensions at various positions instead of at a predetermined or desired position along the thickness direction (Z direction) of the negative electrodes 20 and 20a, and thus adhesive force of the plurality of negative active material layers 25 and 25a to the plurality of negative substrates 21 and 21a may be increased throughout the negative electrodes 20 and 20a. As a result, electron transfer efficiency may be improved at each of the positive electrodes 10 and 10a and the negative electrodes 20 and 20a to increase the charging and discharging reaction speed.

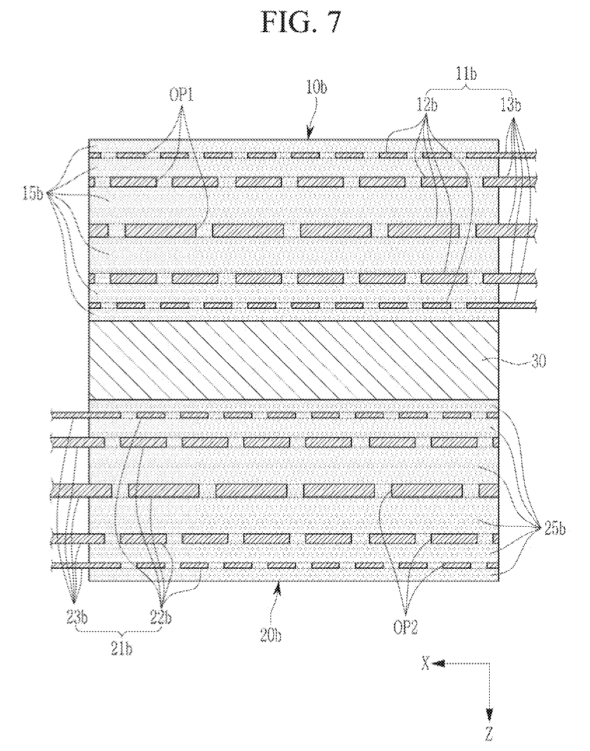

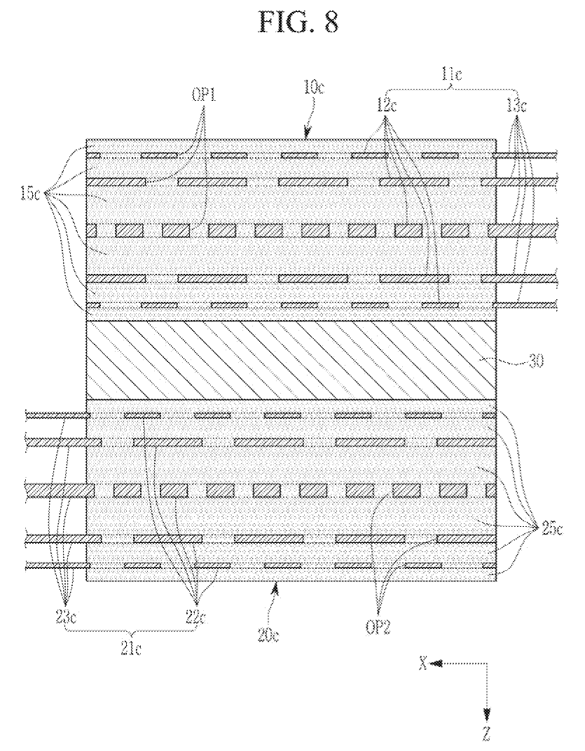

FIGS. 7 and 8 illustrate other modified examples of the electrode assembly shown in FIG. 4.

Referring to FIG. 7, a plurality of first openings OP1 in a plurality of positive active parts 12b may all have substantially the same size. The plurality of positive active parts 12b may have a larger number of first openings OP1 as the thickness thereof decreases and as they are located closer to the negative electrode 20b, and may have a smaller number of first openings OP1 as the thickness thereof increases and as they are located farther from the negative electrode 20b.

In addition, a plurality of second openings OP2 in a plurality of negative active parts 22b may all have substantially the same size. The plurality of negative active parts 22b may have a larger number of second openings OP2 as the thickness thereof decreases and as they are located closer to the positive electrode 10b, and may have a smaller number of second openings OP2 as the thickness thereof increases and as they are located farther from the positive electrode 10b.

Referring to FIG. 8, a plurality of first openings OP1 in a plurality of positive active parts 12c may have different sizes. The plurality of positive active parts 12c may have a plurality of first openings OP1 that are larger in size as the thickness thereof decreases and as they are positioned closer to the negative electrode 20c, and may have a plurality of first openings OP1 that are smaller in size as the thickness thereof increases and as they are positioned farther from the negative electrode 20c. In this case, a plurality of first openings OP1 positioned in one positive active part 12c may have substantially the same size.

In addition, a plurality of second openings OP2 in a plurality of negative active parts 22c may have different sizes. The plurality of positive active parts 12c may have a plurality of first openings OP1 having a larger size as the thickness thereof is smaller and closer to the negative electrode 20c, and the plurality of first openings OP1 having a smaller size as the thickness thereof is larger and positioned farther from the negative electrode 20c. In this case, a plurality of second openings OP2 positioned in one negative active part 22c may have the same size.

Referring to FIGS. 7 and 8, the aperture ratio of each of, or at least one of, the plurality of positive active parts 12b and 12c may increase as it approaches the negative electrodes 20b and 20c. In this example, the aperture ratio represents a ratio of a total area of a plurality of first openings OP1 to an area of the positive active parts 12b and 12c. The plurality of positive active parts 12b and 12c may have a higher aperture ratio when they have a smaller thickness, and a lower aperture ratio when they have greater thickness.

In addition, the aperture ratio of each of, or at least one of, the plurality of negative active parts 22b and 22c may increase closer to the positive electrodes 10b and 10c. In this example, the aperture ratio represents the ratio of the total area of a plurality of second openings OP2 to the area of the negative active parts 22b and 22c. The plurality of negative active parts 22b and 22c may have a higher aperture ratio when they have a smaller thickness, and a lower aperture ratio when they have a greater thickness.

As the positive electrodes 10b and 10c are closer to the negative electrodes 20b and 20c, a larger amount of positive active material may be contained in the positive active parts 12b and 12c due to the increased aperture ratio. As the negative electrodes 20b, 20c are closer to the positive electrodes 10b, 10c, a larger amount of negative active materials may be retained in the negative active parts 22b and 22c due to an increase in aperture ratio.

As described above, each of, or at least one of, the positive electrodes 10b and 10c and the negative electrodes 20b and 20c may increase the loading amount of the active material layers 15b, 15c, 25b, and 25c as a part closer to the counter electrode, thereby increasing charging and discharging efficiency and reaction speed.

In the plurality of positive active parts 12b and 12c and the plurality of negative active parts 22b and 22c, the greatest aperture ratio may be about 70% or less, and the smallest aperture ratio may be about 30% or more. When the greatest aperture ratio exceeds 70%, the strength of the electrode may be reduced, and thus the electrode may be readily damaged, or the defect rate may be increased in the post process (manufacturing of the electrode assembly and assembly of the electrode assembly and the case). When the smallest aperture ratio is less than 30%, the ion transfer path in the electrode may decrease, and thus the resistance of the electrode may increase.

FIGS. 7 and 8 illustrate a case in which there are five of each of the positive active parts 12b and 12c and the negative active parts 22b and 22c, and six layers of each of the positive active material layers 15b and 15c and the negative active material layers 25b and 25c, but as shown in FIG. 6, there may be three of each of the positive active part and the negative active part, and there may be four layers of each of the positive active material layer and the negative active material layer.

Referring back to FIGS. 1 and 2, the electrode assembly 100 in the case 200 may include a positive tab part 13 and a negative tab part 23 positioned on opposite sides to each other. The positive tab part 13 may have a configuration in which the plurality of positive tab parts described above are integrally fixed by, e.g., welding or the like, and the negative tab part 23 may have a configuration in which the plurality of negative tab parts described above are integrally fixed by, e.g., welding or the like.

The rechargeable battery 1000 may include a positive connector 330 physically connecting the positive tab part 13 to the positive terminal 310, and a negative connector 340 physically connecting the negative tab part 23 to the negative terminal 320. The positive terminal 310 may be electrically connected to the positive electrode 10 by a positive connector 330, and the negative terminal 320 may be electrically connected to the negative electrode 20 by a negative connector 340. The cap plate 220 may be insulated from the positive connector 330 and the negative connector 340 by an internal insulator 350.

The cap plate 220 may include a vent hole H and a safety vent 221. The safety vent 221 may be or include a metal plate having a thickness smaller than the thickness of the cap plate 220 and may include a notch 225 that is configured to be broken at a predetermined or desired pressure to relieve internal pressure.

In FIGS. 1 and 2, a reference numeral 226 represents a stopper that seals the electrolyte solution injection hole.

When a plurality of rechargeable batteries 1000 are provided to form a battery module (not shown), a plurality of busbars (not shown) may be coupled to the positive terminal 310 and the negative terminal 320 to connect a plurality of rechargeable batteries in series and/or in parallel.

Although the prismatic rechargeable battery and the stacked type electrode assembly have been described above, the rechargeable battery may be configured in a cylindrical shape or pouch type, and the electrode assembly may be configured in a wound type. Below, a case where the electrode assembly is a wound type is described. The basic configuration of the electrode assembly is the same as the configuration described in the above-described example embodiments and modified examples except for the contents described below.

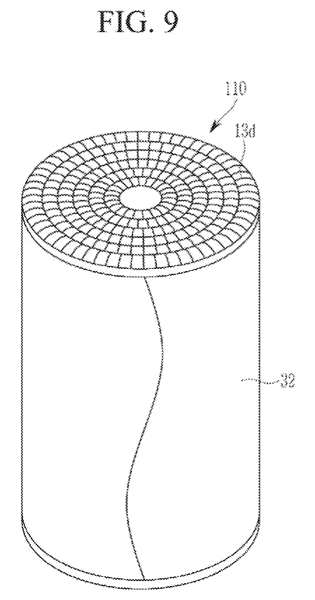

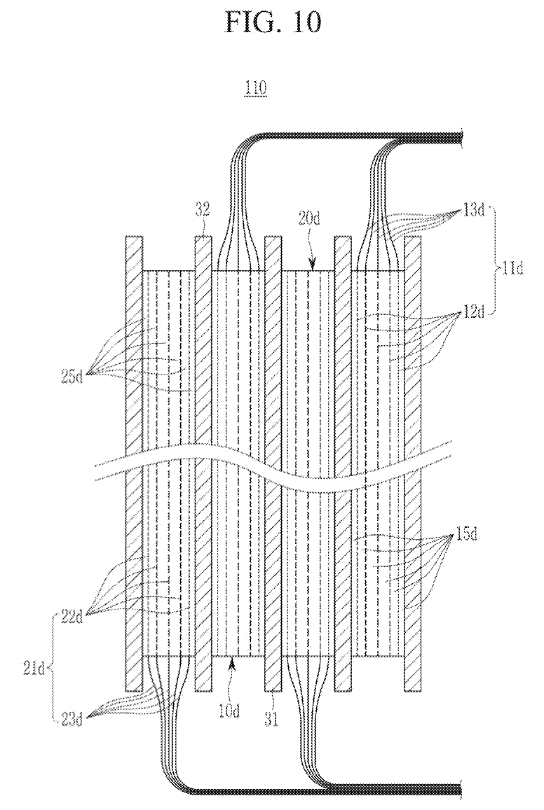

FIG. 9 is a schematic perspective view showing another modified example of the electrode assembly. FIG. 10 is a partially enlarged cross-sectional view of the electrode assembly shown in FIG. 9.

Referring to FIGS. 9 and 10, the electrode assembly 110 may be configured such that a stacked body of a negative electrode 20d, a first separator 31, a positive electrode 10d, and a second separator 32 is wound around a center pin (not shown). That is, the electrode assembly 110 may be a jelly-roll type assembly. Each of, or at least one of, the negative electrode 20d, the first separator 31, the positive electrode 10d, and the second separator 32 may have a long band shape, and their length direction may match the winding direction.

The positive electrode 10d may include a plurality of positive substrates 11d and a plurality of positive active material layers 15d. Each of, or at least one of, the plurality of positive substrates 11d may include a positive active part 12d and a positive tab part 13d. The plurality of positive tab parts 13d may be positioned on one side of the electrode assembly 110 (e.g., an upper side on FIGS. 9 and 10), and may be in close contact with each other. A plurality of positive tab parts 13d may be bent toward the center of the electrode assembly 110.

The negative electrode 20d may include a plurality of negative substrates 21d and a plurality of negative active material layers 25d. Each of, or at least one of, the plurality of negative substrates 21d may include a negative active part 22d and a negative tab part 23d. The plurality of negative tab parts 23d may be positioned on the other side of the electrode assembly 110 (e.g., the lower side on FIGS. 9 and 10) and may be in close contact with each other. The plurality of negative tab parts 23d may be bent toward the center of the electrode assembly 110.

A positive current collector (not shown) on the bent positive tab part 13d may be fixed by welding, or the like. The negative current collector, which is not shown in the bent negative tab part 23d, may be fixed by a joining method such as, e.g., welding.

The plurality of positive active parts 12d, the plurality of positive active material layers 15d, the plurality of negative active parts 22d, and the plurality of negative active material layers 25d may have the same configuration as the configuration of the example embodiment described above with reference to FIG. 4, the modified example described with reference to FIG. 6, and any one of the other modified examples described with reference to FIGS. 7 and 8.

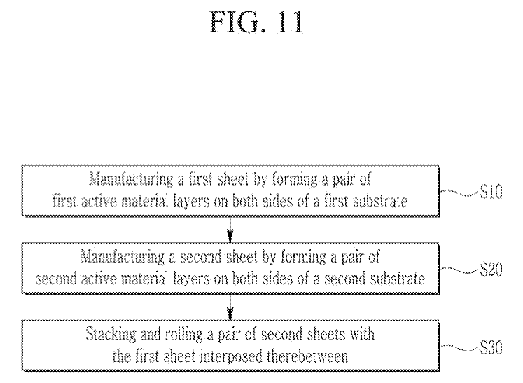

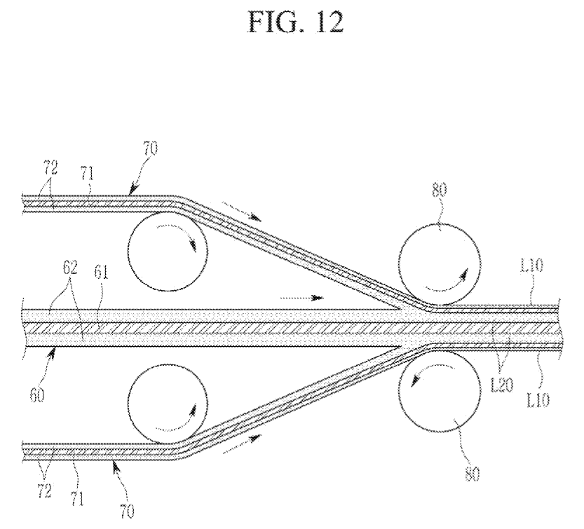

FIG. 11 is a process flowchart illustrating a manufacturing method of an electrode assembly, according to an example embodiment. FIG. 12 is a schematic diagram showing an example of an apparatus for performing the method of manufacturing the electrode assembly discussed in FIG. 11.

Referring to FIGS. 11 and 12, the method of manufacturing an electrode assembly according to the example embodiment includes a first step S10 of manufacturing a first sheet 60 by forming a pair of first active material layers 62 on both surfaces of the first substrate 61 having a plurality of openings, a second step S20 of manufacturing a second sheet 70 by forming a pair of second active material layers 72 on both surfaces of the second substrate 71 having a plurality of openings, and a third step S30 of stacking and rolling a pair of second sheets 70 with the first sheet 60 interposed therebetween.

In the first step S10, a plurality of openings (not shown for convenience) may be formed in the first substrate 61 by using a method such as, e.g., punching or etching. A first active material layer 62 may be formed by coating an active material slurry to one surface of the first substrate 61, and then drying the active material slurry. Then, a first active material layer 62 may be formed by coating an active material slurry onto the opposite face of the first substrate 61 and drying the active material slurry. Through this process, the first sheet 60 may be manufactured.

In the second step S20, a plurality of openings (not shown for convenience) may be formed in the second substrate 71 by using a method such as, e.g., punching or etching. A second active material layer 72 may be formed by coating an active material slurry on one surface of the second substrate 71, and then drying the active material slurry. Then, a second active material layer 72 may be formed by coating an active material slurry onto the opposite face of the second substrate 71, and drying the active material slurry. Through this process, the second sheet 70 may be manufactured.

In the first step S10 and the second step S20, the thickness of the first substrate 61 is greater than the thickness of the second substrate 71, and the thickness of each of the pair of first active material layers 62 is greater than the thickness of each of the pair of second active material layers 72.

In the third step S30, a pair of rollers 80 may be prepared, and the first sheet 60 and the pair of second sheets 70 may be supplied toward the pair of rollers 80. The pair of second sheets 70 may be positioned above and below the first sheet 60 with the first sheet 60 interposed therebetween. The first sheet 60 and the pair of second sheets 70 may be in close contact with each other between the pair of rollers 80. The pair of rollers 80 may be compressed by pressing the stacked body of the first sheet 60 and the pair of second sheets 70.

In the third step S30, the first active material layer 62 positioned on the upper surface of the first substrate 61 may be integrally combined with the second active material layer 72 positioned on the lower surface of the upper second substrate 71 in FIG. 12. In addition, the first active material layer 62 located on the lower surface of the first substrate 61 may be combined into one layer with the second active material layer 72 located on the upper surface of the lower second substrate 71.

A positive electrode or a negative electrode may be manufactured through the first to third steps S10 to S30. When the first substrate 61 and the second substrate 71 are formed of or include a thin aluminum plate or an aluminum mesh, and the first active material layer 62 and the second active material layer 72 include a positive active material, a positive electrode may be manufactured. When the first substrate 61 and the second substrate 71 are formed of or include any one of a thin copper plate, a copper mesh, a thin nickel plate, and a nickel mesh, and the first active material layer 62 and the second active material layer 72 include a negative active material, a negative electrode may be manufactured.

The positive electrode or the negative electrode may include three substrates 61 and 71 and four active material layers. The four active material layers may include a pair of first layers L10 in which the first active material layer 62 is roll pressed, and a pair of second layers L20 in which the first active material layer 62 and the second active material layer 72 are combined and roll pressed. The thickness of each of, or one of, the pair of second layers L20 may be thicker than the thickness of each of, or one of, the pair of first layers L10.

The manufactured positive electrode and negative electrode may be stacked in multiple layers together with a separator therebetween to form a stacked type electrode assembly, or may be stacked and wound together with two separators to form a wound electrode assembly.

Meanwhile, although not illustrated, a third sheet including a third substrate and a pair of third active material layers may be manufactured, and the first sheet, a pair of second sheets, and a pair of third sheets may be supplied to a pair of rollers. The thickness of the third substrate may be thinner than the thickness of the second substrate, and the thickness of the third active material layer may be thinner than the thickness of the second active material layer.

A second sheet and a third sheet may be positioned at an upper side of the first sheet, and a second sheet and a third sheet may be positioned at a lower side of the first sheet. The pair of rollers may compress a stacked body of the first sheet, a pair of second sheets, and a pair of third sheets. In this case, an electrode including five substrates and six active material layers may be manufactured.

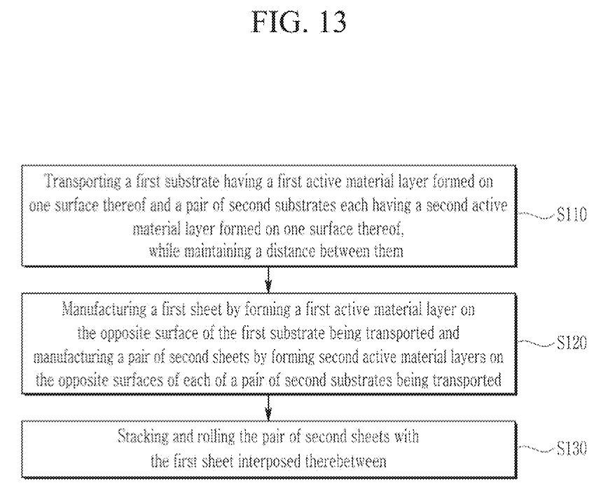

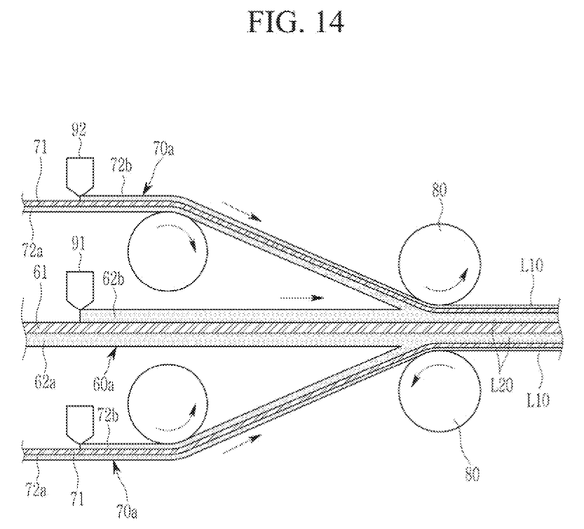

FIG. 13 is a process flowchart illustrating a manufacturing method of an electrode assembly according to another example embodiment. FIG. 14 is a schematic diagram showing an example of an apparatus for performing the 3 method of manufacturing the electrode assembly discussed in FIG. 13.

Referring to FIGS. 13 and 14, a method for manufacturing an electrode assembly according to the example embodiment includes a first step S110 of transporting a first substrate 61 having a first active material layer 62a formed on one surface and a pair of second substrates 71 having a second active material layer 72a formed on one surface while keeping a distance from each other, a second step S120 of forming a first active material layer 62b on the opposite surface of the first substrate 61 being transported to produce a first sheet 60a and simultaneously or contemporaneously forming a second active material layer 72b on the opposite surface of each of the pair of second substrates 71 being transported to produce a pair of second sheets 70a, and a third step S130 of stacking and rolling the pair of second sheets 70a with the first sheet 60a interposed therebetween.

In the device shown in FIG. 14, a first coating machine 91 and a pair of second coating machines 92 may be provided in front of a pair of rollers 80.

Before forming the first active material layer 62a, a plurality of openings (not shown for convenience) may be formed in the first substrate 61, and before forming the second active material layer 72a, a plurality of openings (not shown for convenience) may be formed in the second substrate 71. In the first step S110, the first substrate 61 may be disposed such that the first active material layer 62a faces downward, and the first coating machine 91 may be positioned above the first substrate 61.

The pair of second substrates 71 may be located above and below the first substrate 61 at a distance from the first substrate 61. Each of, or at least one of, the pair of second substrates 71 may be disposed such that the second active material layer 72a faces downward. Each of the pair of second coating machines 92 may be located above each of the pair of second substrates 71. The first substrate 61 and a pair of second substrates 71 may be supplied in parallel to each other from an unwinder (not shown).

In the second step S120, the first coating machine 91 may apply an active material slurry to an upper surface of the first substrate 61 to form a first active material layer 62b. And each of, or one of, the pair of second coating machines 92 may apply an active material slurry to the upper surface of each of, or one of, the pair of second substrates 71 to form a second active material layer 72b. A drying device (not shown) may be installed behind the first coating machine 91 and the pair of second coating machines 92 to dry the coated active material slurry.

In the first step S120 and the second step S130, the thickness of each of, or one of, the pair of second substrates 72 may be thinner than the thickness of the first substrate 61. The thickness of each of, or one of, the pair of second active material layers 72a and 72b may be thinner than the thickness of each of, or one of, the pair of first active material layers 62a and 62b. Since the third step S130 is the same as the third step of the previous example embodiment, redundant descriptions thereof are omitted.

According to the manufacturing method of this example embodiment, it is possible to shorten the manufacturing time of the electrode. However, although not shown, a pair of third substrates with third active material layers formed on one side thereof may be prepared, and in the first step, a pair of third substrates may be transferred in parallel to the upper and lower sides of each of, or one of, the pair of second substrates. In addition, a third coating machine, which is not shown, may be positioned above each of, or one of, a pair of third substrates.

In the second step, a pair of third sheets may be manufactured by forming a third active material layer on opposite surfaces of each of, or one of, the pair of third substrates being transferred. In the third step, the pair of rollers may be compressed by pressing the stacked body of the first sheet, the pair of second sheets, and the pair of third sheets.

Although the example embodiment of the present disclosure has been described, the present disclosure is not limited thereto, and it is possible to perform various modifications within the scope of the claims, the detailed description of the disclosure, and the accompanying drawings, and such modifications fall within the scope of the present disclosure.

What is claimed is:

1. An electrode assembly for a rechargeable battery, the electrode assembly comprising:
a separator; and
a pair of electrodes positioned with the separator interposed therebetween,
wherein, at least one of the pair of electrodes comprises:
a plurality of substrates having a plurality of openings and stacked at a distance from each other along a thickness direction of the electrodes; and
a plurality of active material layers filling the plurality of openings, and positioned between the plurality of substrates and outside the outermost substrate of the plurality of substrates,
wherein at least two of the plurality of substrates have different thicknesses.

2. The electrode assembly for a rechargeable battery of claim 1, wherein:
the plurality of substrates have a smaller thickness away from the center according to the thickness direction.

3. The electrode assembly for a rechargeable battery of claim 1, wherein:
a distance between the plurality of substrates in the thickness direction decreases away from the center according to the thickness direction.

4. The electrode assembly for a rechargeable battery of claim 1, wherein
the plurality of openings have a same size, and
the plurality of substrates have a greater number of openings away from the center along the thickness direction.

5. The electrode assembly for a rechargeable battery of claim 1,
wherein at least two of the plurality of openings have different sizes, and
the plurality of substrates have larger-sized openings away from the center along the thickness direction.

6. The electrode assembly for a rechargeable battery of claim 1, wherein:
the plurality of substrates comprise a plurality of active parts where the plurality of openings are positioned in contact with the plurality of active material layers, and a plurality of tab parts are connected to the plurality of active parts, and
the plurality of tab parts comprise portions that are in close contact with each other.

7. An electrode assembly for a rechargeable battery, the electrode assembly comprising:
a separator; and
a pair of electrodes with the separator interposed therebetween,
wherein at least one of the pair of electrodes comprises:
a plurality of substrates having a plurality of openings and stacked at a distance from each other along a thickness direction of the electrodes; and
a plurality of active material layers filling the plurality of openings, and positioned between the plurality of substrates and outside the outermost substrate of the plurality of substrates,
wherein at least two of the plurality of substrates have different thicknesses, and at least two of the plurality of active material layers have different thicknesses.

8. The electrode assembly for a rechargeable battery of claim 7, wherein:
the plurality of active material layers have a smaller thickness away from the center according to the thickness direction.

9. The electrode assembly for a rechargeable battery of claim 8, wherein:
the plurality of substrates have a smaller thickness away from the center according to the thickness direction.

10. The electrode assembly for a rechargeable battery of claim 7,
wherein the plurality of openings have a same size, and
the plurality of substrates have a greater number of openings away from the center along the thickness direction.

11. The electrode assembly for a rechargeable battery of claim 7,
wherein at least two of the plurality of openings have different sizes, and
the plurality of substrates have larger-sized openings away from the center along the thickness direction.

12. The electrode assembly for a rechargeable battery of claim 7,
wherein the plurality of substrates have a larger aperture ratio away from the center along the thickness direction.

13. The electrode assembly for a rechargeable battery of claim 12, wherein:
a highest aperture ratio in the plurality of substrates is approximately 70% or less, and a smallest aperture ratio is approximately 30% or more.

14. The electrode assembly for a rechargeable battery of claim 7,
wherein the substrate having a smallest thickness in the plurality of substrates has a thickness of approximately 1 µm or more, and
the substrate having a highest thickness in the plurality of substrates has a thickness of approximately 8 µm or less.

15. The electrode assembly for a rechargeable battery of claim 7, wherein:
the active material layer having a smallest thickness in the plurality of active material layers has a thickness of approximately 10 µm or more, and
the active material layer having a highest thickness in the plurality of active material layers has a thickness of approximately 100 µm or less.

16. The electrode assembly for a rechargeable battery of claim 7, wherein:
the plurality of substrates comprise a plurality of active parts where the plurality of openings are positioned in contact with the plurality of active material layers, and a plurality of tab parts are connected to the plurality of active parts, and
the plurality of tab parts comprise portions that are in close contact with each other.

17. A method for manufacturing an electrode assembly for a rechargeable battery, the method comprising:
manufacturing a first sheet comprising a first substrate comprising a plurality of openings and a pair of first active material layers located on both sides of the first substrate;
manufacturing a pair of second sheets, each second sheet comprising a second substrate comprising a plurality of openings and a pair of second active material layers located on both sides of the second substrate; and
stacking the pair of second sheets with the first sheet interposed therebetween, and rolling a stacked body of the first sheet and the pair of second sheets;
wherein a thickness of the first substrate is greater than a thickness of the second substrate, and a thickness of at least one of the pair of first active material layers is greater than a thickness of at least one of the pair of second active material layers.

18. The method for manufacturing an electrode assembly for a rechargeable battery of claim 17, wherein:
a pair of rollers are prepared, and
the first sheet and the pair of second sheets are transferred toward the pair of rollers while being spaced apart from each other, and are stacked and rolled while passing between the pair of rollers.

19. The method for manufacturing an electrode assembly for a rechargeable battery of claim 17, wherein:
a first coating machine and a pair of second coating machines are prepared,
the first substrate, having the first active material layer formed on a bottom surface thereof, forms the first active material layer on a top surface thereof while passing through the first coating machine during transfer, and
the pair of second substrates, each having the second active material layer formed on a bottom surface thereof, form the second active material layer on a top surface thereof while passing through the second coating machine during transfer.

20. The method for manufacturing an electrode assembly for a rechargeable battery of claim 19, wherein:
a pair of rollers are prepared behind the first coating machine and the pair of second coating machines, and
the first sheet and the pair of second sheets are stacked and rolled while passing between the pair of rollers.
